(19) United States
(12) Patent Application Publication
(10) Pub. No.: US 2023/0274673 A1
(43) Pub. Date: Aug. 31, 2023

(54) SUSPENDED DISPLAY

(71) Applicant: BAY MEDIA LTD, London (GB)

(72) Inventor: Marcus SCOTT, London (GB)

(21) Appl. No.: 18/016,310

(22) PCT Filed: Jul. 12, 2021
(86) PCT No.: PCT/EP2021/069366

§ 371 Date: Jan. 13, 2023

(30) Foreign Application Priority Data
Jul. 13, 2020 (GB) 2010762.9

(51) Int. Cl. G09F 15/00; G09F 13/18

(52) U.S. Cl. CPC G09F 15/0025; G09F 13/18; G09F 15/0012; G09F 2007/1843

(57) ABSTRACT

The present invention relates to a display for displaying an image carried by, or generated/projected on, a substrate. The display comprises at least one frame member arranged to define an open frame (200), the at least one frame member comprising at least a first frame portion and a second frame portion, the second frame portion being spaced from the first frame portion across the open frame, and tensioning means for connecting the first frame portion to the second frame portion, or for holding or supporting the first frame portion relative to the second frame portion. The tensioning means (400) is adjustable to provide for one or more of a first state where all of the weight of the display is supported by the first frame portion, a second state where all of the weight of the display is supported by the second frame portion, and/or an intermediate state where a proportion of the weight of the display is supported by each of the first frame portion and the second frame portion. The present invention also relates to a method of forming the display.

The present invention relates to a display intended to be suspended from above, and in particular to a display intended to be suspended at height from a supporting structure, such as a truss, joist, beam, or ceiling.

A prominent way to advertise goods and services, or to display information, is to suspend a banner, poster, or the like, from a ceiling. For maximum effect, it is desirable to have a display with as large an area as possible. If advertising material or any other image or information to be displayed is printed on a fabric, plastics, paper or other substrate, or to be projected thereon, a substantial support frame is required in order to maintain the substrate taut. However, a limit is placed on the size of that frame (the support frame) by the weight that the supporting structure (e.g. ceiling) can withstand and, if provided, the capacity also of a hoist used to raise and lower the display.

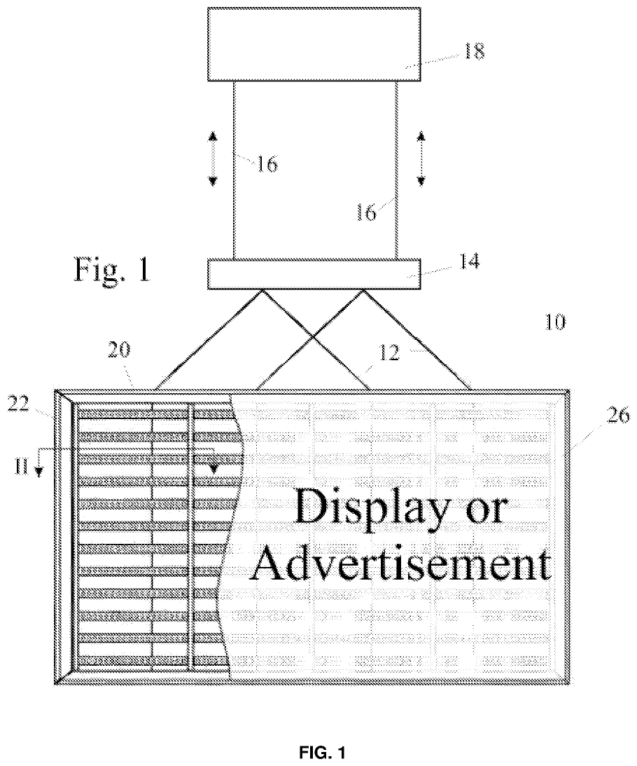

In order to avoid the need to erect scaffolding whenever the information displayed on a non-dynamic display is to be changed (e.g. for substitution of a printed substrate), it has previously been proposed, for example as described in EP1672608, to mount a remotely controlled motorised hoist on the ceiling, and to then suspend the display below, so as to enable it to be raised and lowered at will. Such an arrangement is also shown in FIG. 1, and is as described and published in GB2519083A of the present applicant. Here, a display 10 is suspended by means of cables 12 from a bar 14 that is itself suspended by cables 16 from a hoist 18. The hoist 18 is mounted on a ceiling and may be constructed in the manner taught in EP1672608.

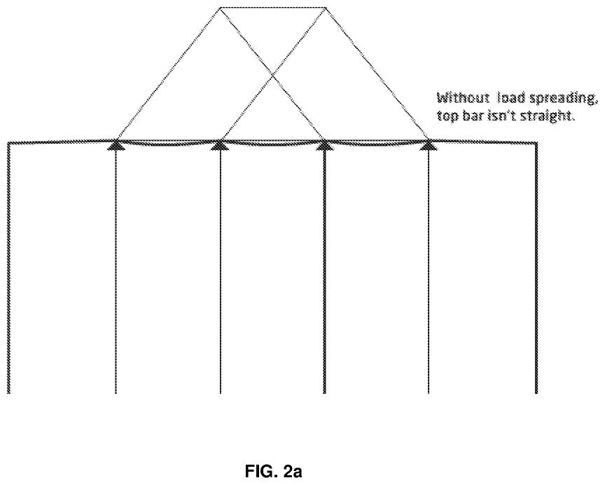

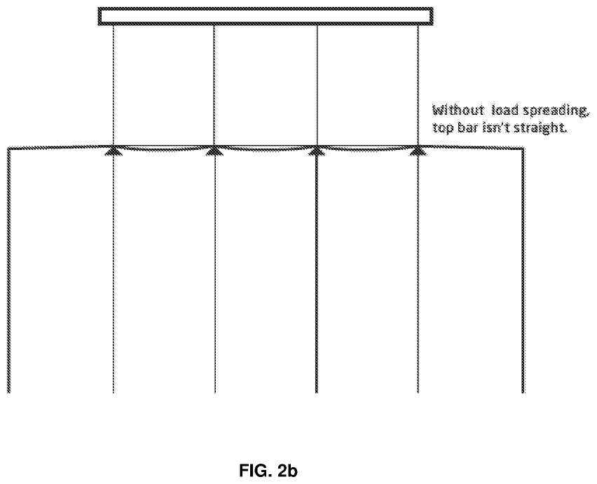

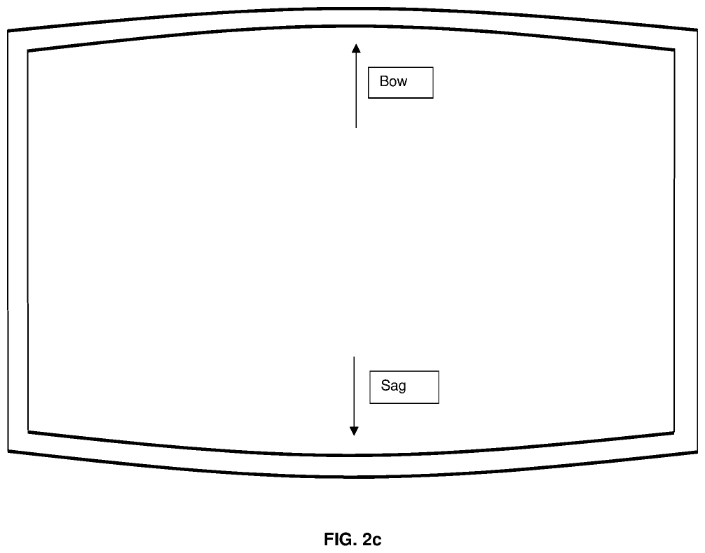

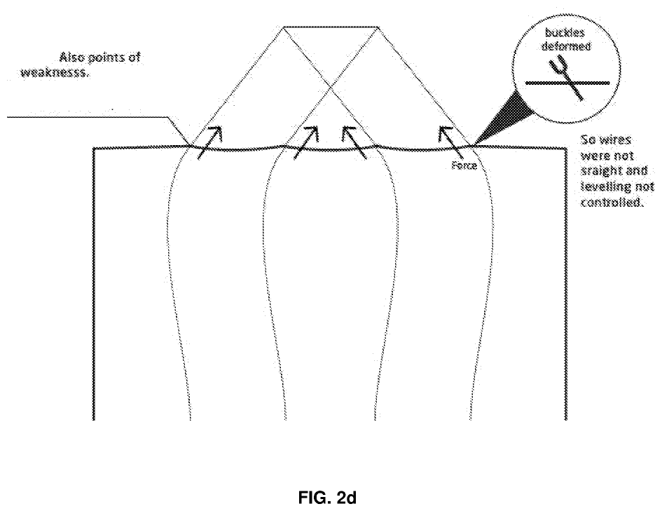

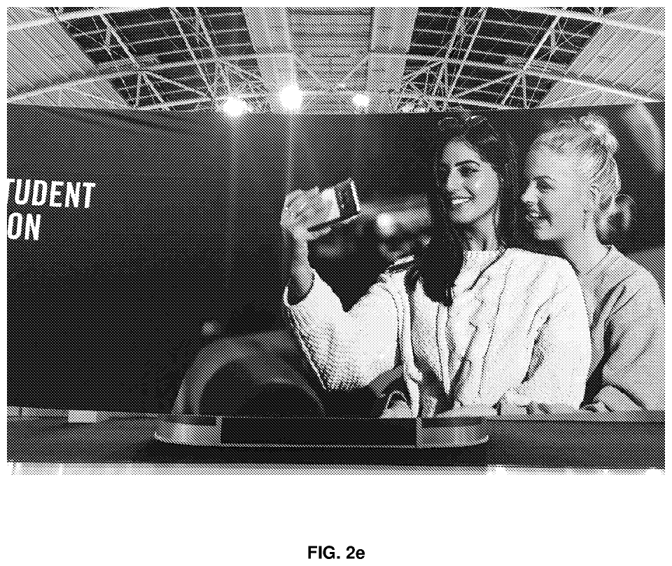

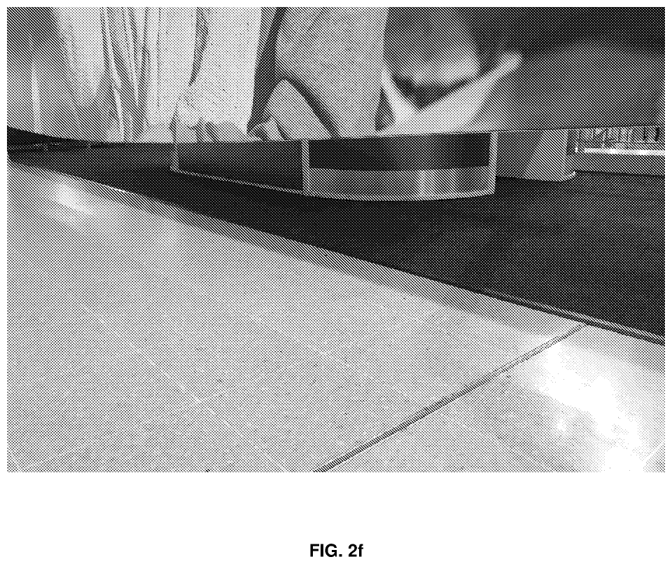

With a conventional suspended display, suspension cables are attached to the upper edge of the display and the weight of the display is relied upon to maintain the display in a vertical plane. However, if a large rectangular open frame is suspended in this manner, there is a tendency for the upper frame member to bow upwards, and for the lower frame member to sag downwards under the weight of the frame and the substrate stretched over the frame, as illustrated in FIG. 2c. This compromises the look of the display, and even its structural integrity.

To address these problems in the art, the present applicant has previously developed a light yet rigid frame on which a substrate bearing an image to be displayed can be supported, as shown in FIG. 1, and as described and published in GB2519083A. This seeks to address the problem of bow and sag described above by suspending the frame 10 on suspension cables 12 from a lower member of the frame, and does so by passing the suspension cables 12 through apertures in an upper member 20 of the frame. This arrangement also seeks to steady the display, and to maintain it in a vertical plane.

Similar arrangements have been proposed in the art, such as those described and published in JPH0906245.

Other less preferred options include reinforcing the frame with internal members or a framework, but this results in a frame that is unacceptable from a weight perspective, and prevents suspending from ceilings.

Another alternative is the use of a hanging banner with a length of scaffolding or other like pole arranged in a horizontal pocket provided along both the top and the bottom of the banner. However, this alternative can suffer from more limited capacity and structural integrity, when compared to a frame, including the possibility of catastrophic failure as a result of any misalignment of the horizontal pockets and/or tearing of the substrate, and such an arrangement cannot be backlit. Consequently, this option introduces more risk and is less premium from an advertiser viewpoint.

Whilst the arrangement previously developed by the present applicant shown in FIG. 1 and described and published in GB2519083A improves upon the prior art and enables larger displays to be deployed at height, the applicant has identified aesthetic issues and structural integrity limitations. This affects those embodiments described and published in JPH0906245 also. For example, a particular problem identified by the applicant concerns the passing of the suspension cables through the apertures provided in the upper member of the frame. Cable spooling inside the frame and cable snagging/catching in the apertures was found in certain instances to cause the frame to hang at an angle to the horizontal, as cable lengths were then uneven. This results in an undesirable aesthetic, and an uneven load distribution. To address these problems, cable guides or simple cable clamps (“cable fixings”) were introduced in the top frame member, but these in themselves introduced further problems, as follows:
i) The cable fixings did not spread the load sufficiently, laterally, across the top frame member, causing the frame to wave at the top as shown in FIG. 2a and FIG. 2b. The waves amplified imperfections in the display, resulting in an undesirable aesthetic (as shown by the “wrinkles” in the upper left photograph of FIG. 2e);
ii) The cable fixings did not allow for controlled adjustability of tension in the suspension cables (i.e. the interface of the suspension cables with the top and bottom frame members) to stop the frame from sagging at the top and bottom, as shown in in the photographs of FIG. 2e and FIG. 2f. The applicant has established that this is a consequence of a lack of control over the sharing of the weight of the display between the top and bottom frame members, a fundamental issue addressed by the present invention;
iii) The cable fixings did not permit transfer of the load carried by the frame from an angled force at the top frame member (due to an angled supporting suspension cable—see FIG. 2d) to a vertical force internally within the frame. This caused the cable fixings to adopt an angle (i.e. to twist in the aperture) in, and relative to, the top frame member, out of vertical plumb, as illustrated in FIG. 2d. As a result, the frame and the display is not straight, resulting in an undesirable aesthetic, and causing stress points which could fatigue in the future, compromising (or at least limiting the capacity of) the structural integrity of the frame.

These problems are addressed by the present invention. The present invention provides for improved structural integrity and increased load capacity, enabling larger, higher quality displays (improved aesthetic) to be deployed at height.

Furthermore, in providing improved structural integrity and increased load capacity, the present invention has opened up the opportunity to implement digital (dynamic) displays, in particular those using thin film technology, as the substrate. In the past, only where the ceiling or other supporting structure is very strong has it is been possible to adopt the much heavier option of use of a full digital unit, as in Dusseldorf airport. However, most ceilings or supporting structures cannot accommodate the weight of a full digital unit, certainly of the size desirable for use at any height. The present invention opens up the possibility of implementing digital displays in more locations.

Furthermore, the present invention opens up the possibility of implementing the open frame as a support structure for the suspended display of a wide range of items, including pictures, tapestries, paintings and works of fine art, in galleries and museums, by way of non-limiting example.

The present invention provides, in a first aspect, a display for displaying an image carried by, or generated/projected on, a substrate, the display comprising:
at least one frame member arranged to define an open frame;
the at least one frame member comprising at least a first frame portion and a second frame portion, the second frame portion being spaced from the first frame portion across the open frame; and
tensioning means for connecting the first frame portion to the second frame portion, wherein:
the tensioning means is adjustable to provide for one or more of at least three states, a first state where all of the weight of the display is supported by the first frame portion, a second state where all of the weight of the display is supported by the second frame portion, and an intermediate state where a proportion of the weight of the display is supported by each of the first frame portion and the second frame portion.

In a second aspect, the present invention provides a method of forming a display, the method comprising the steps of:
arranging at least one frame member to define an open frame, the at least one frame member comprising at least a first frame portion and a second frame portion;
arranging the second frame portion to be spaced from the first frame portion across the open frame; and
providing tensioning means for connecting the first frame portion to the second frame portion, wherein:
the tensioning means is adjustable to provide for one or more of at least three states, a first state where all of the weight of the display is supported by the first frame portion, a second state where all of the weight of the display is supported by the second frame portion, and an intermediate state where a proportion of the weight of the display is supported by each of the first frame portion and the second frame portion.

The present invention will now be described, by way of example only, with reference to the accompanying drawings, in which:

FIG. 1 is a schematic illustration of a prior art display of the present applicant, as described and published in GB2519083A;

FIGS. 2a and 2b are schematic illustrations of a prior art display hung, respectively, from angled and vertical suspension cables and showing the problem of a top frame member experiencing “wave” due to the load not being spread sufficiently;

FIG. 2c is a schematic illustration of a prior art display showing the problem of “bow” and “sag”;

FIG. 2d is a schematic illustration of a prior art display showing the problem of the fixings of the top frame member adopting an angle (or “twist”) relative to the top frame member (out of vertical plumb), as is the case also for the suspension cables;

FIGS. 2e and 2f are a photographic illustrations of a prior art display experiencing “sag”, and the resulting compromised aesthetic (“wrinkles”) in the upper left region of the substrate;

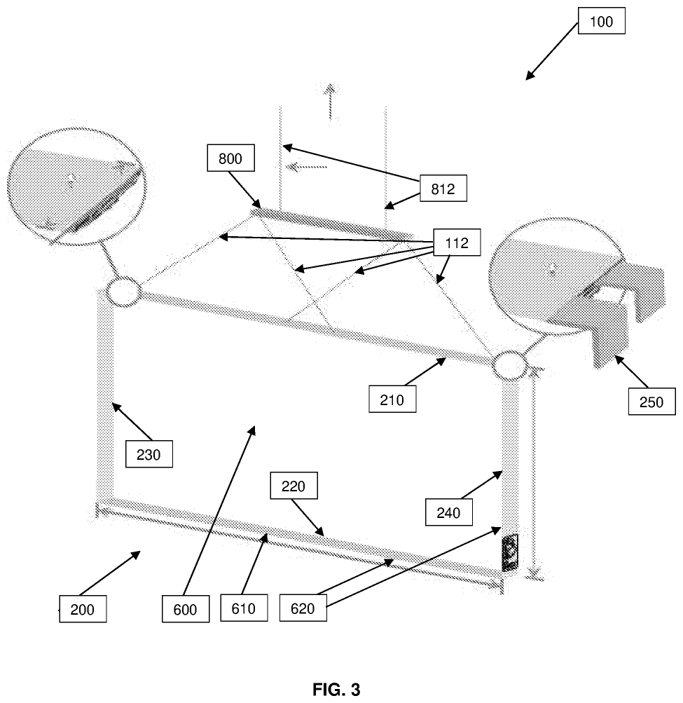

FIG. 3 is a schematic perspective view of a first preferred embodiment of suspended display according to the present invention, supported from above;

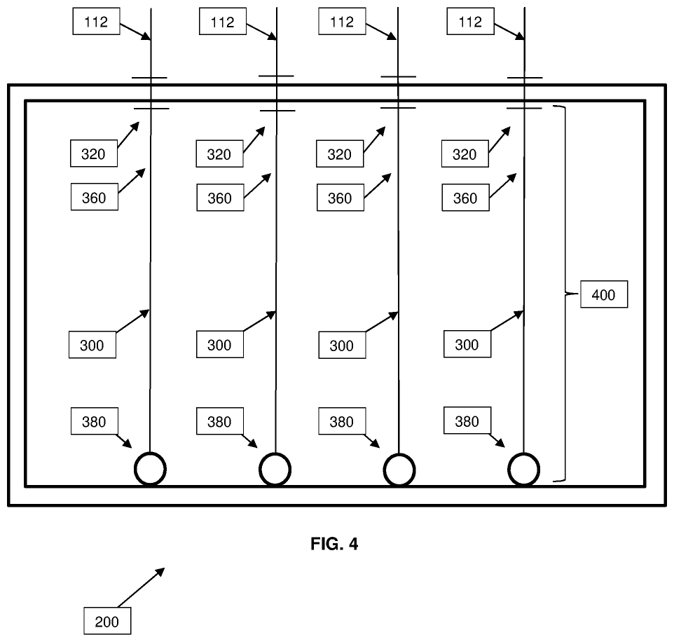

FIG. 4 is a schematic front elevation view of a first preferred embodiment open frame according to the present invention;

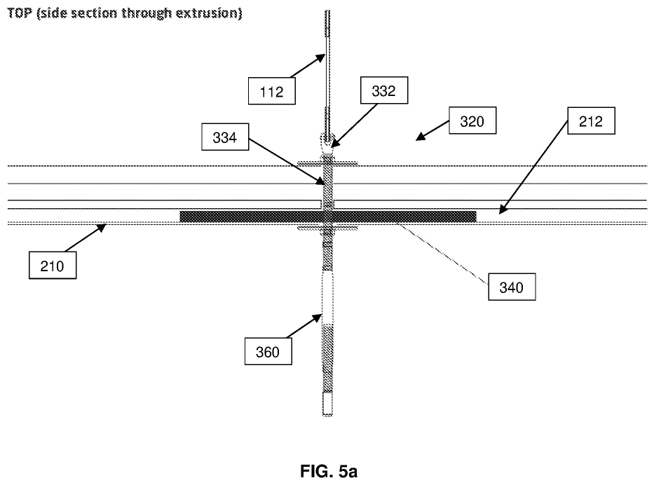

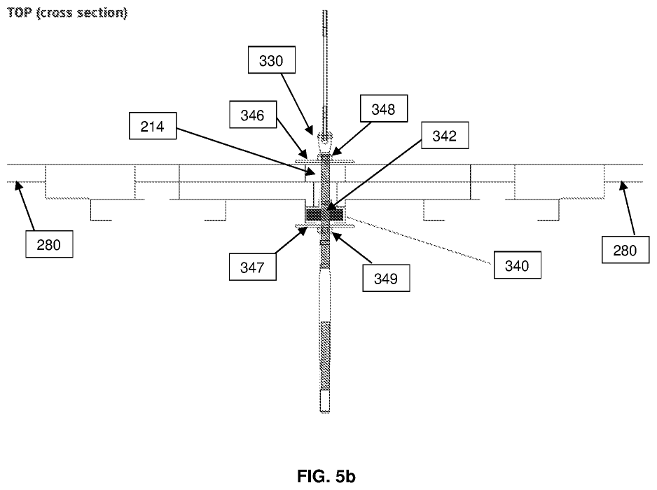

FIG. 5a is a schematic partial elevation section view of a top frame member of the display of FIG. 4, showing the rigid connector assembly;

FIG. 5b is a schematic partial cross section view of a top frame member of the display of FIG. 4, showing the rigid connector assembly;

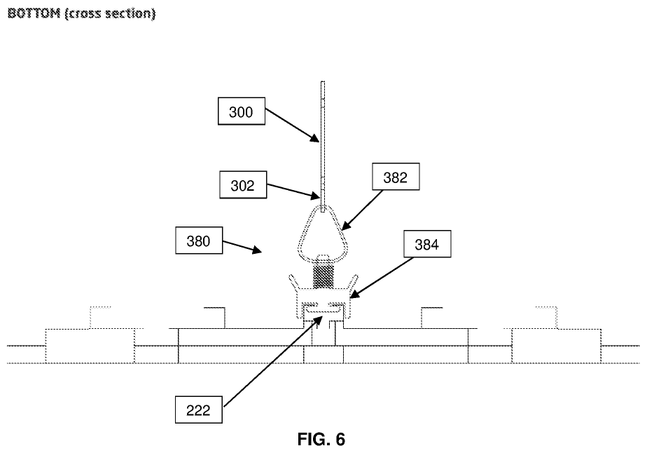

FIG. 6 is a schematic partial cross section view of a bottom frame member of the display of FIG. 4, showing the securing clip assembly; and

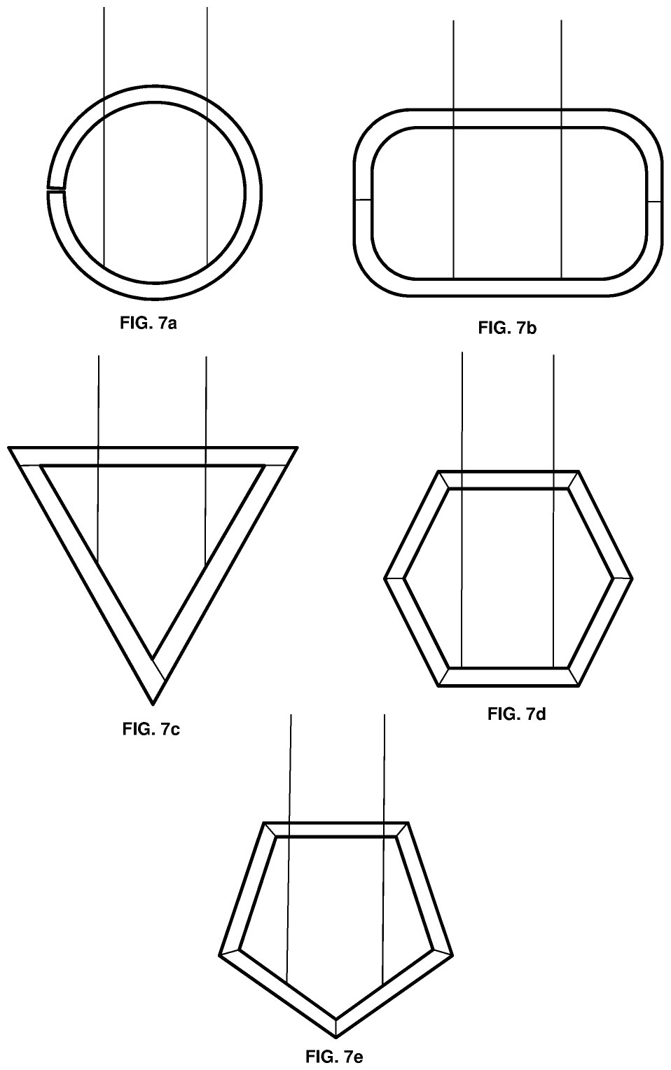

FIGS. 7a to 7e are schematic front elevation views of alternative suspended displays, all according to further preferred embodiments of the present invention, each adopting a different shape of supporting frame.

Referring first to FIG. 3, there is shown a schematic perspective view of a suspended display 100 according to a first preferred embodiment of the present invention. The suspended display 100 is supported from above via suspension cables 112 and an optional suspension bar 800 that is itself suspended by cables 812 from a hoist (not shown). The hoist is mounted on, or otherwise supported by, a ceiling or other support structure and may be constructed in the manner taught in EP1672608 as published, which allows the suspended display 100 to be raised and lowered.

Weight constraints are placed on the suspended display 100 when it is suspended (as intended) in this manner, in terms of both the load bearing capacity of the ceiling or other supporting structure, and of the hoist. The suspended display 100 is therefore designed to minimise weight, but also to avoid the bowing and/or sagging phenomenon which can result, in order to maximise the area of the suspended display while remaining within the weight constraints and maintaining structural integrity and the best possible aesthetic.

In order to address these aims, the suspended display 100 is formed as an open (support) frame 200, that is to say a frame having one or more frame members that are joined to one another and then bound an open space. This is in contrast to a closed frame where the area bounded by the frame is occupied by a rigid body, such as a board. The open frame 200 can adopt any shape that may be of beneficial use, such a circle or oval (as shown in FIG. 7a), an obround (as shown in FIG. 7b), a triangle (as shown in FIG. 7c), a hexagon (as shown in FIG. 7d), or a pentagon (as shown in FIG. 7e), all by way of non-limiting example only. The shapes can be achieved using multiple frame members being joined or urged together, or from a single frame member formed appropriately with its respective ends meeting and being joined or urged together. The open frame can be arranged with its major dimension arranged horizontally or vertically, or at any angle in-between (i.e. in landscape or portrait orientation, or adopting any orientation to suit).

Referring next to FIG. 4, the illustrated open frame 200 is rectangular with a long horizontal upper frame member 210, a long horizontal lower frame member 220 and two shorter vertical side frame members 230 (left) and 240 (right). Each of the frame members 210, 220, 230, 240 is formed as an extrusion having, for example, the cross section shown in FIG. 3, FIG. 5b and FIG. 6. These extrusions are conveniently made of aluminium, which offers the advantage of strength combined with low weight. However, any suitable material or composite may be beneficially employed. In cross section, the extrusion can be seen to take a form necessary to provide structural integrity, to include channels and other features beneficially required to receive the components used to assemble the open frame 200, and to receive the edge 600 or edge regions 620 of the substrate 600, whilst maintaining a low profile to avoid casting a shadow on the substrate 600. For example, the front and rear facing edges of the extrusion can be formed with grooves 280 for receiving the edge 610 or edge regions 620, optionally reinforced, of a substrate 600 stretched over the open frame 200. As an alternative, a bead may be forced into the grooves 280 to clamp a fold of the edge 610 or edge region 620 of the substrate 600 within the groove 280 after the substrate sheet 600 has been stretched to overlie the groove 280, with any excess substrate then being trimmed.

In the rectangle form of open frame 200 shown, the frame members 210, 220, 230, 240 are joined to one another at each corner by mitring and then inserting an elbow piece 250 into the respective joining ends or end portions of their box sections. As the resulting open frame 200 is then restrained or put under tension by the tensioning means 400 (described below) these, and the substrate 600 ultimately stretched across and received by the one or more frame members 210, 220, 230, 240, each serve also to hold the frame members 210, 220, 230, 240 together, such that no other means of attachment or reinforcement is needed. However, fasteners and/or adhesives may be used where desired.

Referring next to FIG. 6, a plurality of frame support cables 300 are provided. Each frame support cable 300 is attached securely to the lower frame member 220 using a securing clip assembly 380. A crimped loop 302 is formed at a first (lower) end of each frame support cable 300, and this is received in a loop member 382 of the securing clip assembly 380. The loop member 382 is connected to an engagement member 384 of the securing clip assembly 380. The engagement member 384 is slidingly received in a channel 222 of the lower frame member 220, and biased into frictional locking engagement therewith. This provides for lateral sliding adjustment, where necessary.

Referring next to FIG. 5a and FIG. 5b, each frame support cable 300 passes across (upwardly) the inner space bounded by the frame members 210, 220, 230, 240 and is provided at the second (upper) end with, and secured to, the first (lower) end of a turnbuckle 360. The second (upper) end of the turnbuckle 360 secures to, by way of a screw thread engagement, a rigid connector assembly 320 in turn engaged with the upper frame member 210.

The rigid connector assembly 320 comprises a fork member 330, a support bar 340, two bearing washers 346, 347 and two nuts 348, 349. The support bar 340 is elongate and slidingly received in a channel 212 of the upper frame member 210, and dimensioned both so as to be a tight fit therein, and to provide a substantial bearing surface thereagainst, to resist lateral, rotational and torsional movement thereof, including in particular by way of the forces (including torsional forces) received by the rigid connector assembly 320. The support bar 340 is provided with a through-hole 342 for alignment with a corresponding through-hole 214 in the upper frame member 210. The support bar 340 may be provided with a low friction coating, e.g. Xylan, to aid in its insertion and positioning in the channel 212 of the upper frame member 210, such that the through-hole 342 of the support bar 340 aligns with the through-hole 214 of the upper frame member 210. The fork member 330 comprises a head 332 and an elongated shank 334, the elongated shank 334 including a screw thread. The nut 348 first, and then the bearing washer 346, are first introduced on the elongated shank 334 of the fork member 330 before the elongated shank 334 is passed through the aligned through-holes 214 and 342 respectively of the upper horizontal frame member 210 and the support bar 340, passing from outside of the open frame 200 and on through to the inside. Next, the bearing washer 347 first, and the nut 349, are then introduced on the portion of the elongated shank 334 passing through to the inside of the open frame 200, and the end of elongated shank 334 (opposite the head 332) is then screwed into the free second (upper) end of the turnbuckle 360. The rigid connector assembly 320 is then made good (rigid) by tightening of the nuts 348 and 349 against the bearing washers 346 and 347 respectively, which in turn bear against outer (upper) and inner (lower) surfaces of the upper frame member 210, as shown in FIG. 5a and FIG. 5b.

This combination of i) rigid connector assembly 320, ii) turnbuckle 360, iii) frame support cable 300 and iv) securing clip assembly 380 collectively provides a tensioning means 400 which provides an ability to vary at will the effective length tying the upper and lower frame members 210 and 220 together, so as to constrain any separating movement therebetween, or to positively place the open frame 200 under tension (the vertical frame members 230, 240 can in this scenario experience compressive forces). Although just one tensioning means 400 can be employed, it is usual, given the size of the open frame 200, to employ multiple tensioning means 400 arranged across the span of the open frame 200. In alternative embodiments, the tensioning means 400 may comprise only one item (e.g. an elongate rotatable rod with thread portions) or a more limited combination of items (e.g. a support cable and a turnbuckle).

Once the open frame 200 is assembled, each of the adjustable tensioning means 400 provided are adjusted by selective tightening or loosening of the turnbuckle 360. This serves to provide for one or more of at least three states, a first state where all of the weight of the display is supported by the upper frame member (first frame portion), a second state where all of the weight of the display is supported by the lower frame member (second frame portion), and an intermediate state where a proportion of the weight of the display is supported by each of the upper frame member (first frame portion) and the lower frame member (second frame portion).

One or two substrate 600 sheets are provided, and can be attached to and supported by the open frame 200 as has been described above.

If two substrate 600 sheets bearing the images to be displayed are used and are to be backlit, then a lighting system as described and illustrated in the applicant's patent GB2519187B can be beneficially employed. In this case, power supply cables may, if desired, be connected to a plug that registers with a socket only when the display 100 is raised into its operating position. In this way, when the display 100 is lowered for maintenance work to be carried out, such as replacement of the substrate 600 sheets, the electrical power to any lighting system will be disconnected automatically.

The suspended display 100 can then be supported from above using the head(s) 332 of fork(s) 330 of the rigid connector assembly(ies) 320. This is achieved via the suspension cables 112 each provided with a crimped loop formed at a first (lower) end and connected to a head 332 of a fork 330 of a rigid connector assembly, and at a second (upper) end likewise connected to an optional suspension bar 800 that is itself suspended by hoist cables 812 from a hoist (not shown). The hoist is mounted on, or otherwise supported by, a ceiling or other support structure and may be constructed in the manner taught in EP1672608 as published, which allows the suspended display 100 to be raised and lowered.

Each feature disclosed in this specification (including the accompanying claims and drawings), may be replaced by alternative features serving the same, equivalent or similar purpose, unless expressly stated otherwise. Thus, unless expressly stated otherwise, each feature disclosed is one example only of a generic series of equivalent or similar features.

In addition, all of the features disclosed in this specification (including the accompanying claims and drawings), and/or all of the steps of any method or process so disclosed, may be combined in any combination, except combinations where at least some of such features and/or steps are mutually exclusive.

Accordingly, while different embodiments of the present invention have been described above, any one or more or all of the features described, illustrated and/or claimed in the appended claims may be used in isolation or in any alternative combination in any embodiment. As such, any one or more feature may be removed, substituted and/or added to any of the feature combinations described, illustrated and/or claimed. For the avoidance of doubt, any one or more of the features of any embodiment may be combined and/or used separately in a different embodiment with any other feature or features from any of the embodiments. As such, the scope of the present invention is that as set forth in the appended claims.

1. A display for displaying an image carried by, or generated/projected on, a substrate, the display comprising:
at least one frame member arranged to define an open frame;
the at least one frame member comprising at least a first frame portion and a second frame portion, the second frame portion being spaced from the first frame portion across the open frame; and
tensioning means for connecting the first frame portion to the 10 second frame portion, or for holding or supporting the first frame portion relative to the second frame portion, wherein:
the tensioning means is adjustable to provide for one or more of a first state where all of the weight of the display is supported by the first frame portion, a second state where all of the weight of the display is supported by the second frame portion, and/or an intermediate state where a proportion of the weight of the display is supported by each of the first frame portion and the second frame portion.

2. A display for displaying an image carried by, or generated/projected on, a substrate, the display comprising:
at least one frame member arranged to define an open frame;
the at least one frame member comprising at least a first frame portion and a second frame portion, the second frame portion being spaced from the first frame portion across the open frame; and
tensioning means for connecting the first frame portion to the second frame portion, or for holding or supporting the first frame portion relative to the second frame portion, wherein:
the tensioning means is adjustable to provide for a proportion of the weight of the display to be supported by each of the first frame portion and the second frame portion.

3. A display as claimed in claim 1 or claim 2 wherein the at least one frame member comprises at least a first frame member comprising the first frame portion and a second frame member comprising the second frame portion.

4. A display as claimed in claim 3 wherein the at least one frame member further comprises at least a third frame member disposed between the first frame member and the second frame member.

5. A display as claimed in claim 4 wherein the at least one frame member further comprises at least a fourth frame member disposed between two of the first, second or third frame members.

6. A display as claimed in claim 1 or claim 2 wherein a first end or a first end portion of the first frame member is engageable with, or connectable to, a second end or a second end portion of the first frame member to engage, or form an connection between, the end(s) or the end portion(s) of the first frame member.

7. A display as claimed in any one of claims 3 to 5 wherein an end or an end portion of one frame member is engageable with, or connectable to, an end or an end portion of another frame member to engage, or form a connection between, the end(s) or the end portion(s) of the frame members.

8. A display as claimed in any one of claims 3 to 5 wherein an end or an end portion of a plurality of frame members is engageable with, or connectable to, an end or an end portion of another of the plurality of frame members to form a plurality of engagements or connections between the end(s) or the end portion(s) of the plurality of frame members.

9. A display as claimed in any one of the preceding claims wherein the tensioning means can be adjusted to impart a compressive force(s) in one or more of the frame members.

10. A display as claimed in any one of the preceding claims wherein the tensioning means can be adjusted to prevent a separation of one or more of the frame members.

11. A display as claimed in any one of the preceding claims wherein the at least one frame member comprises means for receiving one or more edges or edge regions of a substrate.

12. A display as claimed in any one of the preceding claims further comprising a rigid connector assembly, wherein:
the upper frame member is at least partially elongate in a longitudinal axis thereof and provided with at least one aperture therethrough;
the at least one aperture is arranged substantially perpendicular to the longitudinal axis of the upper frame member; and
at least a portion of the rigid connector assembly extends though the at least one aperture and interacts with the upper frame member to prevent rotation of the portion of the rigid connector assembly in the at least one aperture relative to the longitudinal axis of the upper frame member.

13. A display as claimed in claim 12 wherein the portion of the rigid connector assembly further comprises a disc provided with a through hole which aligns with the at least one aperture of the upper frame member.

14. A display as claimed in claim 12 wherein the portion of the rigid connector assembly further comprises an elongate bar provided with a through hole which aligns with the at least one aperture of the upper frame member.

15. A display as claimed in any one of claims 12 to 14 wherein the upper frame member comprises at least upper and lower flanges extending in the longitudinal axis of the upper frame member and between which the portion of the rigid connector assembly, the disc or the elongate bar is received.

16. A display as claimed in claim 15 wherein an upper surface and a lower surface of the portion of the rigid connector assembly, the disc or the elongate bar are arranged immediately adjacent the at least upper and lower flanges extending in the longitudinal axis of the upper frame member.

17. A display as claimed in any one of claims 12 to 16 wherein the tensioning means comprises one or more of a cable, a turnbuckle, an elongated shank provided with at least a portion of thread.

18. A display as claimed in any one of the preceding claims wherein the display is double sided, with substrate being secured to both front and rear faces of the open frame.

19. A display as claimed in any one of the preceding claims wherein the at least one frame member is formed by way of an extrusion.

20. A display as claimed in any one of the preceding claims wherein the at least one frame member is formed from aluminium, an alloy or a composite.

21. A display as claimed in any one of the preceding claims, wherein the display is rectangular with upper and lower horizontal portions of the at least one frame member, and two shorter vertical portions of the at least one frame member.

22. A display as claimed in any one of claims 1 to 20, wherein the display is rectangular with upper and lower horizontal portions of the at least one frame member, and two longer vertical portions of the at least one frame member.

23. A display as claimed in any one of the preceding claims wherein a lighting system is housed in the open frame, to enable the substrate sheets to be backlit or, a space is housed to separate two directionally opposed digital screens.

24. A display as claimed in any one of the preceding claims, wherein the one or more suspension cables can be wound in or out by a remotely controllable hoist to allow the display to be raised and lowered.

25. A display as claimed in any one of the preceding claims, wherein the one or more suspension cables are attached to a bar that is suspended by hoist cables from a remotely controllable hoist.

26. A display as claimed in any one of the preceding claims, wherein the tensioning means is adjustable to enable the proportion of the weight of the display supported by each of the first frame portion and the second frame portion to be set, selected and/or varied by adjustment of the tensioning means.

27. A method of forming a display, the method comprising the steps of:
arranging at least one frame member to define an open frame, the at least one frame member comprising at least a first frame portion and a second frame portion;
arranging the second frame portion to be spaced from the first frame portion across the open frame; and
providing tensioning means for connecting the first frame portion to the second frame portion, or for holding or supporting the first frame portion relative to the second frame portion, wherein:
the tensioning means is adjustable to provide for one or more of a first state where all of the weight of the display is supported by the first frame portion, a second state where all of the weight of the display is supported by the second frame portion, and/or an intermediate state where a proportion of the weight of the display is supported by each of the first frame portion and the second frame portion.

28. A method of forming a display, the method comprising the steps of:
arranging at least one frame member to define an open frame, the at least one frame member comprising at least a first frame portion and a second frame portion;
arranging the second frame portion to be spaced from the first frame portion across the open frame; and
providing tensioning means for connecting the first frame portion to the second frame portion, or for holding or supporting the first frame portion relative to the second frame portion, wherein:
the tensioning means is adjustable to provide for a proportion of the weight of the display to be supported by each of the first frame portion and the second frame portion.

29. A method of forming a display as claimed in claim 27 or claim 28, wherein the tensioning means is adjustable to enable the proportion of the weight of the display supported by each of the first frame portion and the second frame portion to be set, selected and/or varied by adjustment of the tensioning means.
